(19) United States
(12) Patent Application Publication
(10) Pub. No.: US 2023/0252673 A1
(43) Pub. Date: Aug. 10, 2023

(54) METHOD FOR COMPUTING POSITION OF STAR IN STAR TRACKER

(71) Applicant: CANON DENSHI KABUSHIKI KAISHA, Saitama-ken (JP)

(72) Inventor: Tomoya INAKAWA, Ota-ku (JP)

(21) Appl. No.: 18/159,157

(22) Filed: Jan. 25, 2023

(30) Foreign Application Priority Data
Feb. 8, 2022 (JP) 2022-018038

(51) Int. Cl. G06T 7/73; G06T 7/11; H04N 17/00; G01K 1/14

(52) U.S. Cl. CPC G06T 7/73; G01K 1/14; G06T 7/11; H04N 17/002; G06T 2207/30168

(57) ABSTRACT

A star tracker captures an image of a star and output the image, searches out, from a plurality of pixels constituting the image, a peak pixel having a luminance value higher than luminance values of neighboring pixels neighboring the peak pixel, determines an extraction range from which to extract, from the image, a partial image containing the peak pixel, and computes a star position based on luminance values of a plurality of pixels constituting the partial image. The apparatus determines the extraction range based on at least one of the luminance value of the peak pixel, a position of the peak pixel within the image, and a parameter correlated with a temperature of the image sensor, such that noise in the partial image is reduced.

### CROSS-REFERENCE TO RELATED APPLICATION

This application claims priority to and the benefit of Japanese Patent Application No. 2022-018038 filed on Feb. 08, 2022, the entire disclosure of which is incorporated herein by reference.

### BACKGROUND OF THE INVENTION

### Field of the Invention

The present disclosure relates to a method for computing the position of a star in a star tracker.

### Description of the Related Art

A satellite such as an artificial satellite or a space probe (called “satellite” hereinafter) is equipped with a star tracker, which detects the positions of fixed stars and determines the attitude of the satellite based on the detected positions of the fixed stars. The star tracker is one example of a satellite attitude sensor, which calculates star positions from star images obtained by an image sensor, identifies the stars by comparing the calculated positions to positions in a star catalog, and outputs the attitude of the satellite.

The images obtained by the image sensor contain noise in addition to images of stars. As such, when determining an image region to be used for calculating star positions from an image, it is necessary to take steps to ensure there is no noise in the image region. Japanese Patent Laid-Open No. 5-066128 proposes a method in which neighboring pixels are searched in a spiral pattern centered on a pixel having a luminance that is an extreme value (a peak pixel), and to use pixels up to a pixel having a luminance below a threshold to calculate star positions. Japanese Patent Laid-Open No. 2009-176083, meanwhile, proposes a method for extracting a group of star images by recursively finding bright pixels adjacent to a pixel of interest.

However, these methods of determining an image region to be used to calculate star positions involves a large number of memory accesses and therefore has a high computational load.

### SUMMARY OF THE INVENTION

The present disclosure provide a star tracker comprising an image sensor configured to capture an image of a star and output the image, and at least one processor configured to search out, from a plurality of pixels constituting the image, a peak pixel having a luminance value higher than luminance values of neighboring pixels neighboring the peak pixel, to determine an extraction range from which to extract, from the image, a partial image containing the peak pixel, and to compute a star position based on luminance values of a plurality of pixels constituting the partial image, wherein the at least one processor is further configured to determine the extraction range based on at least one of the luminance value of the peak pixel, a position of the peak pixel within the image, and a parameter correlated with a temperature of the image sensor, such that noise in the partial image is reduced.

### BRIEF DESCRIPTION OF THE DRAWINGS

FIG. 1 is a block diagram illustrating a star tracker.

FIG. 2 is a diagram illustrating operations by a star position calculation unit.

FIG. 3 is a diagram illustrating operations by a peak search unit.

FIG. 4 is a diagram illustrating operations by a size adjustment unit.

FIG. 5 is a diagram illustrating operations by a position computation unit.

FIG. 6 is a flowchart illustrating a star position calculation method.

FIG. 7 is a diagram illustrating a method for determining a filter size based on a peak luminance value.

FIG. 8 is a flowchart illustrating a star position calculation method.

FIG. 9 is a diagram illustrating a method for determining a filter size based on temperature information.

FIG. 10 is a flowchart illustrating a star position calculation method.

FIG. 11 is a diagram illustrating a method for determining a filter position and size based on the position of a peak pixel.

### DESCRIPTION OF THE EMBODIMENTS

Hereafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Configuration of Star Tracker

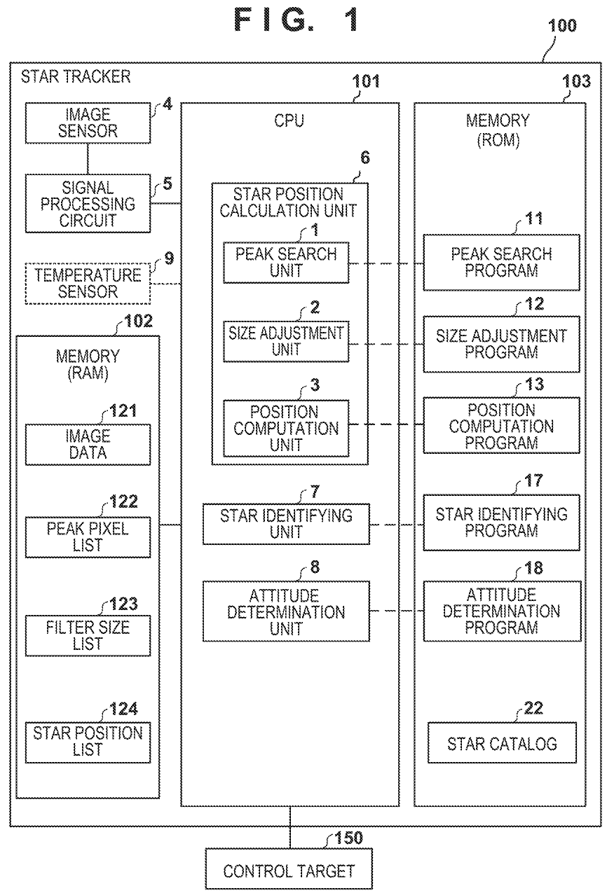

FIG. 1 is a block diagram illustrating a star tracker 100 that supplies an attitude control signal to a control target 150, which is a satellite or the like. The star tracker 100 includes an image sensor 4, a signal processing circuit 5, a temperature sensor 9 (optional), a CPU 101, and memories 102 and 103. The CPU 101 is a processor or processing circuitry that implements various functions by executing programs stored in the memory 103, which is read-only memory (ROM) or the like. However, some or all of the functions implemented by the CPU 101 may be realized by an integrated circuit such as an ASIC, a FPGA, a DSP, or the like. “ASIC” is an acronym for “application-specific integrated circuit”. “FPGA” is an acronym for “field-programmable gate array”. “DSP” is an acronym for “digital signal processor”.

The image sensor 4 captures an image of a star through an optical system (not shown) and outputs an image signal to the signal processing circuit 5. The signal processing circuit 5 converts the image signal (analog data) into digital image data 121 and outputs that data. The image data 121 may be temporarily stored in the memory 102, which is random access memory (RAM).

A star position calculation unit 6 is a function implemented by the CPU 101, which extracts star candidates from the image data 121, calculates the position of each star candidate within the image, and outputs the calculation results to a star identifying unit 7. The star position calculation unit 6 includes a peak search unit 1, which is implemented by the CPU 101 executing a peak search program 11. The peak search unit 1 searches out peak pixels from the image data 121. Information on the peak pixels found through the search may be stored in a peak pixel list 122. Furthermore, the star position calculation unit 6 includes a size adjustment unit 2, which is implemented by the CPU 101 executing a size adjustment program 12. The size adjustment unit 2 is a function for adjusting a partial image extraction range (e.g., a cutout size (a filter size); in the following descriptions, “extraction” will be referred to as “cutting out”, and the extraction range will be referred to as a “filter size”). Filter sizes determined for corresponding peak pixels are stored in the memory 102 as a filter size list 123. The star position calculation unit 6 includes a position computation unit 3, which is implemented by the CPU 101 executing a position computation program 13. The position computation unit 3 cuts out a partial image from the overall image according to the filter size for each peak pixel, registered in the filter size list 123; computes the positions of the star candidates from the cut-out partial image; and outputs those positions to the star identifying unit 7. Note that the positions of the star candidates may be registered in a star position list 124.

The star identifying unit 7 is a function implemented by the CPU 101 executing a star identifying program 17. The star identifying unit 7 identifies a star based on the positions of the star candidates, and outputs the identification result to an attitude determination unit 8.

The attitude determination unit 8 is a function implemented by the CPU 101 executing an attitude determination program 18. The attitude determination unit 8 compares the star identified by the star identifying unit 7 with a star catalog 22 calculated in advance and stored in the memory 103, and calculates a current attitude of the satellite. Furthermore, the attitude determination unit 8 outputs the calculated attitude to the control target 150.

### Star Position Calculation Unit

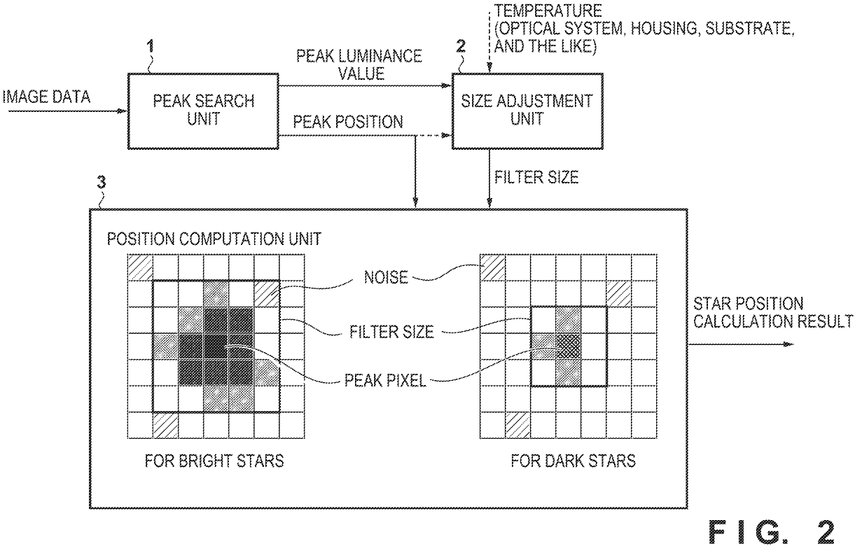

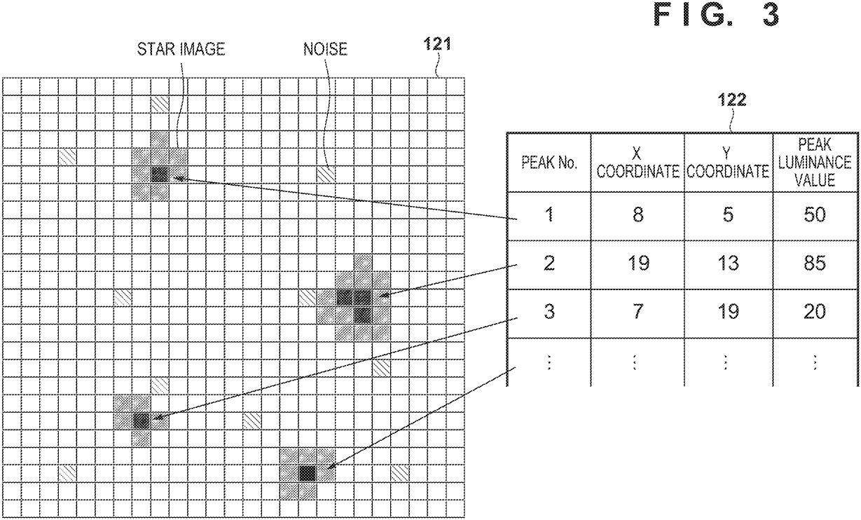

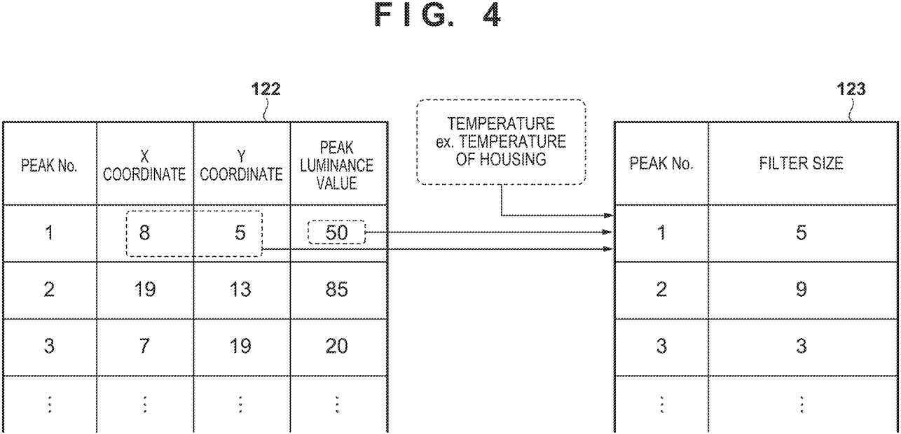

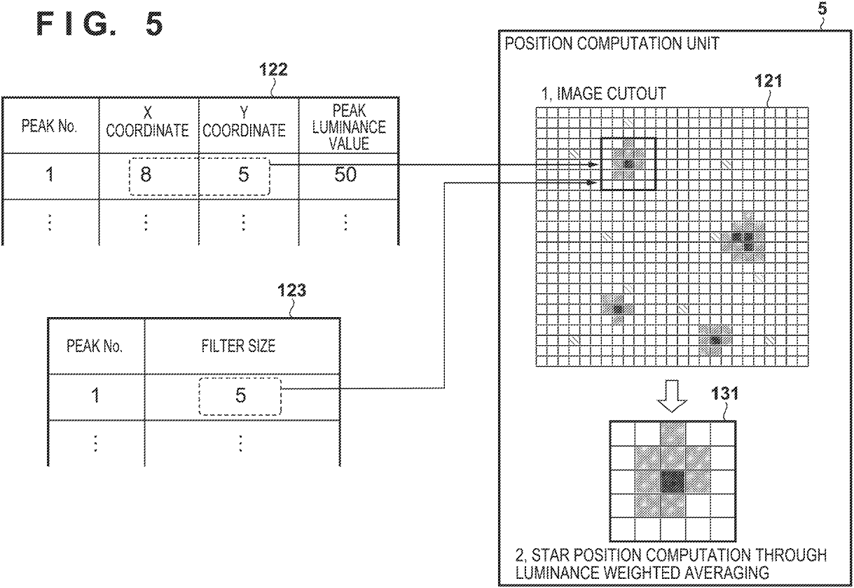

FIG. 2 is a diagram illustrating the flow of computations performed by the star position calculation unit 6. FIG. 3 is a conceptual diagram illustrating operations by the peak search unit 1. FIG. 4 is a conceptual diagram illustrating operations by the size adjustment unit 2. FIG. 5 is a conceptual diagram illustrating operations by the position computation unit 3.

The peak search unit 1 compares the luminance value of each pixel in an image expressed by the image data 121 with a threshold, and searches out a pixel having a luminance value that is at least the threshold, for example. The peak search unit 1 further compares the luminance value of the pixel found (a peak pixel candidate) with the luminance values of a plurality of neighboring pixels adjacent to the pixel found. As a result, a pixel having a luminance value higher than the luminance values of the neighboring pixels is identified as the peak pixel. As illustrated in FIG. 3, the peak search unit 1 stores the position of the peak pixel found (a peak position) and the luminance value thereof (the peak luminance value) in the peak pixel list 122. Identification information (a peak number) may be assigned to each peak pixel or each star image in the peak pixel list 122. The peak position may be expressed by X and Y coordinates in the image data 121.

The size adjustment unit 2 adjusts or determines the filter size based on at least one piece of information among the peak luminance value and peak position of each peak pixel stored in the memory 102 by the peak search unit 1 and a temperature obtained by the temperature sensor 9, and adds the filter size to the filter size list 123. As illustrated in FIG. 2, optimizing the filter size (the size of the partial image which is cut out) reduces the effect of noise while also reducing the number of memory accesses and computation time. According to FIG. 2, the filter size can be optimized according to the peak luminance value. In other words, the effect of noise is reduced by varying the filter size between bright stars and dark stars. FIG. 2 illustrates a state where the filter size is larger (5×5) for bright stars having a large peak luminance value and smaller (3×3) for dark stars having a small peak luminance value, and this will be described in detail later.

As illustrated in FIG. 4, the size adjustment unit 2 determines the filter size based on the peak position (X and Y coordinates) and the peak luminance value read out from the peak pixel list 122, and registers the determined filter size in the filter size list 123. Similar to the peak pixel list 122, identification information (a peak number) is assigned to each peak pixel in the filter size list 123, and relationships between the peak pixels and the filter sizes are held. This makes it possible to associate different filter sizes with each peak pixel.

Temperature may be taken into account when determining the filter size. The temperature of the optical system of the image sensor 4, the temperature of the housing of the star tracker 100, the temperature of a circuit board on which the image sensor 4 is mounted, and the like can be given as examples of the temperature obtained by the temperature sensor 9. The reason for taking temperature into account is that heat is the main cause of noise. Generally, as the temperature of the image sensor 4 rises, thermal noise increases and appears as noise (false bright spots) in the image. The filter size may therefore be determined such that the noise reduction level increases (the filter size decreases) as the temperature of the image sensor 4 rises. The filter size may also be determined by combining a plurality of parameters from among the peak luminance value and peak position of each peak pixel and the temperature obtained by the temperature sensor 9 or the like. For example, the filter size may be determined according to the peak luminance value as described above and then corrected on the basis of the temperature obtained by the temperature sensor 9 or the like to determine a final filter size.

As illustrated in FIG. 5, the position computation unit 3 executes (1) image cutout processing and (2) star position computation through luminance weighted averaging. The position computation unit 3 determines one star candidate (peak pixel) for computation according to the identification information registered in the peak pixel list 122. This will be called an “i-th peak pixel (peak No. i)”. The position computation unit 3 obtains the position (X and Y coordinates) of the i-th peak pixel from the peak pixel list 122. The position computation unit 3 furthermore reads out, from the filter size list 123, the filter size registered in association with the i-th peak pixel. Then, the position computation unit 3 sets a cutout region, centered on the position of the i-th peak pixel, according to the filter size, and cuts out a partial image 131 from the image data 121. Next, the position computation unit 3 computes a luminance weighted average value of the positions for each pixel in the partial image 131, and outputs the value as an in-image star position.

The following will describe methods for adjusting the filter size in detail. A first embodiment will describe using the peak luminance value. A second embodiment will describe using temperature information. Finally, a third embodiment will describe using the peak position. It is assumed that, for example, the luminance of each pixel can take on a value of 0 to 127.

### First Embodiment

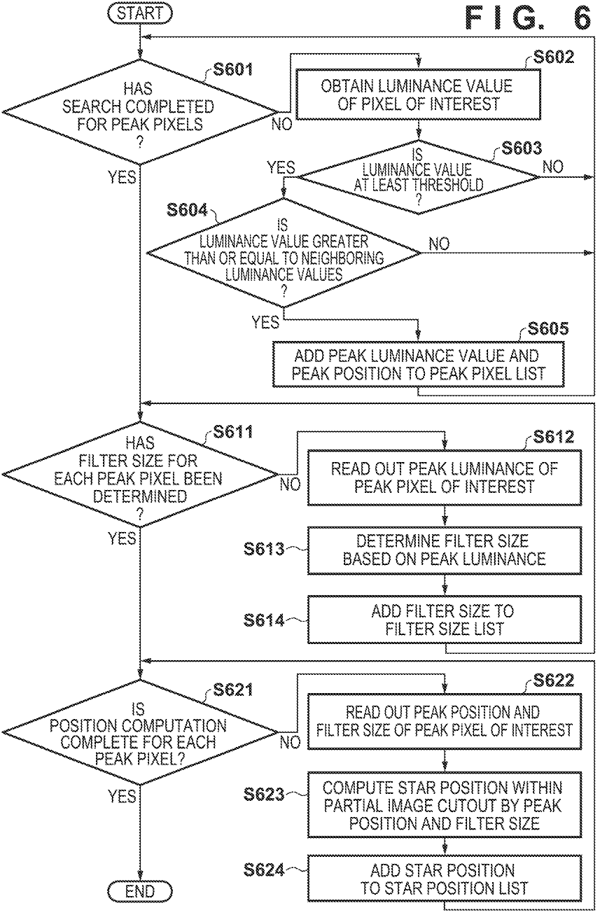

FIG. 6 is a flowchart illustrating a method for determining the filter size based on the peak luminance value.

In step S601, the CPU 101 (the peak search unit 1) determines whether the search is complete for all peak pixels in the image. For example, the CPU 101 determines whether the processing from step S602 to step S605 has been executed for all of N pixels constituting the image data 121 (where i = 1 to N). If the search for the peak pixels is not complete, the CPU 101 moves to step S602.

In step S602, the CPU 101 (the peak search unit 1) obtains the luminance value of the i-th pixel (a pixel of interest) from the image data 121.

In step S603, the CPU 101 (the peak search unit 1) determines whether the luminance value of the pixel of interest is at least a threshold Th_p set in advance. The threshold Th_p is set to a higher value than a lower limit value Th_z of the luminance for selecting the pixel to be used in the calculation when performing the weighted averaging in the star position calculation. The CPU 101 moves to step S604 if the luminance value of the pixel of interest is at least the threshold Th_p. However, the CPU 101 moves to step S601 if the luminance value of the pixel of interest is not at least the threshold Th_p.

In step S604, the CPU 101 (the peak search unit 1) determines whether the luminance value of the pixel of interest is greater than or equal to the luminance value of all the neighboring pixels adjacent to the pixel of interest (neighboring luminance values). The number of neighboring pixels is a maximum of 8 and a minimum of three (because only three pixels are adjacent to the pixels in the four corners of the image). The CPU 101 moves to step S605 if the luminance value of the pixel of interest is greater than or equal to the neighboring luminance values. However, the CPU 101 moves to step S601 if even one of the neighboring luminance values is greater than the luminance value of the pixel of interest.

In step S605, the CPU 101 (the peak search unit 1) adds the luminance value and the position of the pixel of interest to the peak pixel list 122 as a peak luminance value and a peak position. The CPU 101 then moves to step S601.

If it is determined in step S601 that the processing from step S602 to step S605 has been executed for all of the N pixels constituting the image data 121, the CPU 101 moves from step S601 to step S611.

In step S611, the CPU 101 (the size adjustment unit 2) determines whether the filter size has been determined for all the peak pixels registered in the peak pixel list 122. For example, when M peak pixels are registered in the peak pixel list 122, it is determined whether the filter size has been determined for each of the M peak pixels. If a peak pixel for which the filter size has not been determined remains, the CPU 101 moves to step S612.

In step S612, the CPU 101 (the size adjustment unit 2) reads out, from the peak pixel list 122, a peak luminance value L_p of a j-th peak pixel (a peak pixel of interest) among the M peak pixels. j is an integer from 1 to M. j is incremented by 1 at a time.

In step S613, the CPU 101 (the size adjustment unit 2) determines the filter size based on the peak luminance value L_p of the peak pixel of interest. A plurality of thresholds may be used when determining the filter size. For example, the filter size may be determined through a comparison with five levels of luminance thresholds (Th1 = 20, Th2 = 40, Th3 = 60, Th4 = 80, and Th5 = 100). In the present embodiment, when Th1 ≤ L_p < Th2, the filter size is determined to be “3”. When Th2 ≤ L_p < Th3, the filter size is determined to be “5”. When Th3 ≤ L_p < Th4, the filter size is determined to be “7”. When Th4 ≤ L_p < Th5, the filter size is determined to be “9”. When Th5 ≤ L_p, the filter size is determined to be “11”. Here, the unit of the filter size is the vertical and horizontal number of pixels in the filter.

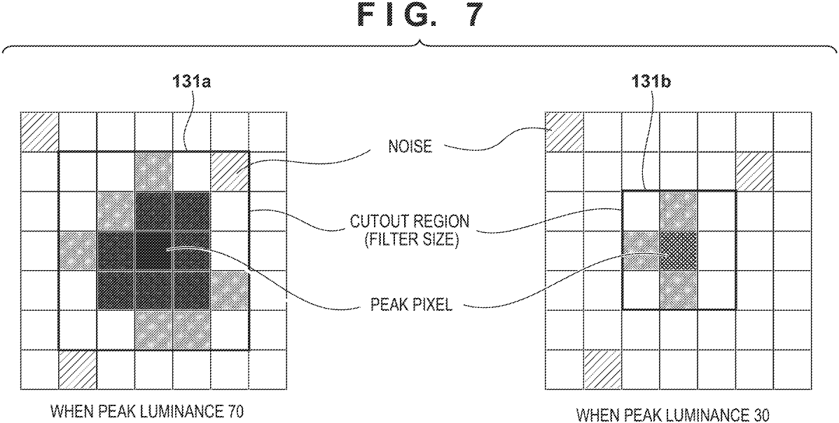

As illustrated in FIG. 7, the cutout size of the partial image (the filter size) is determined according to the peak luminance value. A partial image 131a is a region, having a peak luminance value of 70, that is cut out by a filter having a size of “7”. A partial image 131b is a region, having a peak luminance value of 30, that is cut out by a filter having a size of “3”.

Generally, a star image is larger when the peak luminance value is higher, and is smaller when the peak luminance value is lower. As such, making the filter size relatively smaller when the peak luminance value is lower reduces the probability of noise being present within the pixel region of the partial image 131b.

A filter size conversion formula stored in the memory 103 may be used as another method for determining the filter size based on the peak luminance value. The input value of the filter size conversion formula is the peak luminance value, and the output value is the filter size. Note that when the output value is not an integer, processing for rounding up or down to an integer may be employed.

Using such methods eliminates the need for repeated calculations to determine the filter size. The processing can therefore be completed at high speed.

In step S614, the CPU 101 (the size adjustment unit 2) adds the filter size to the filter size list 123. The size adjustment unit 2 registers the peak number of the pixel of interest in association with the filter size in the filter size list 123. The CPU 101 then moves to step S611. If it is determined in step S611 that the filter size has been determined for all the peak pixels to be registered in the peak pixel list 122, the CPU 101 moves from step S611 to step S621.

In step S621, the CPU 101 (the position computation unit 3) determines whether the position computation is complete for each peak pixel (star candidate) registered in the peak pixel list 122. For example, when M peak pixels are registered in the peak pixel list 122, it is determined whether the filter size has been determined for each of the M peak pixels. If a peak pixel for which the filter size has not been determined remains, the CPU 101 moves to step S622.

In step S622, the CPU 101 (the position computation unit 3) reads out, from the peak pixel list 122, the peak position of a k-th peak pixel (a peak pixel of interest), and reads out the filter size of the pixel of interest from the filter size list 123. k is an integer from 1 to M. k is incremented by 1 at a time.

In step S623, the CPU 101 (the position computation unit 3) cuts out the partial image 131 based on the peak position and the filter size of the pixel of interest, and computes the star position within the partial image 131. For example, the position computation unit 3 computes the star position by executing luminance weighted averaging within the partial image 131.

In step S624, the CPU 101 (the position computation unit 3) adds the star position to the star position list 124.

FIG. 7 illustrates a square partial image 131 being cut out, with the number of pixels on one side representing the filter size, but this is merely one example. The partial image 131 may be cut out with a filter shape aside from a square, such as a rhombus or the like, according to the shape and the like of the star image in the optical design. In this case, the filter size may be determined in light of a filter size definition based on the corresponding filter shape.

### Second Embodiment

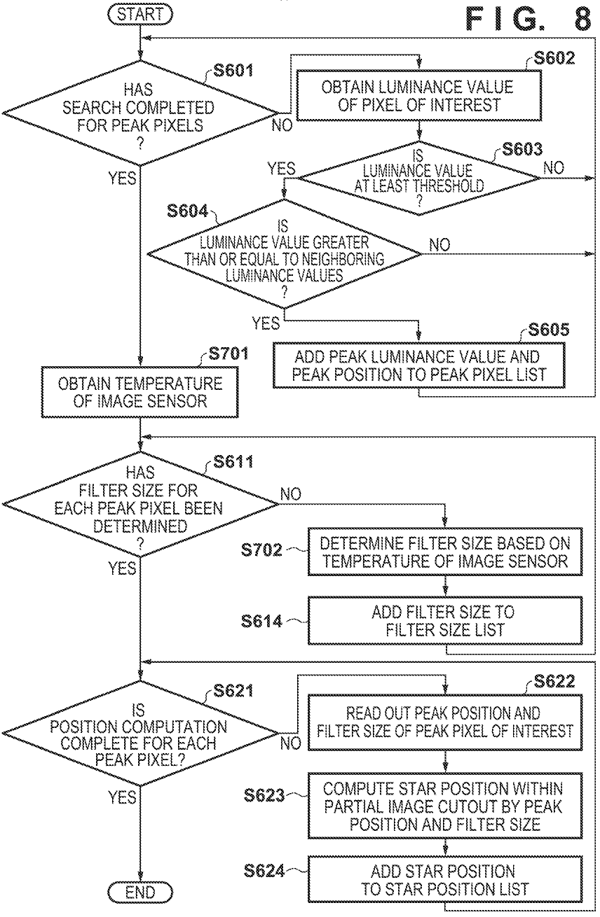

FIG. 8 is a flowchart illustrating a method for determining the filter size based on temperature information. Of the processes in FIG. 8, processes that are the same as in FIG. 6 are given the same reference signs, and will not be described. Once the peak pixel search is completed through the processing from step S601 to step S605, the CPU 101 moves from step S601 to S701.

In step S701, the CPU 101 (the size adjustment unit 2) obtains a temperature T of the image sensor 4 from the temperature sensor 9. As described above, temperature information correlated with the occurrence of noise, such as the temperature of the optical system or the temperature of the housing, may be used as well. The CPU 101 moves to step S611 from step S701.

If it is determined in step S611 that a peak pixel for which the filter size has not been determined remains, the CPU 101 moves from step S611 to step S702.

In step S702, the CPU 101 (the size adjustment unit 2) determines the filter size based on the temperature T of the image sensor 4. For example, the filter size is determined by comparing the temperature T with three levels of temperature thresholds (Th1 = 20° C., Th2 = 40° C., and Th3 = 60° C.). In the present embodiment, when T < Th1, the filter size is determined to be “9”. When Th1 ≤ T < Th2, the filter size is determined to be “7”. When Th2 ≤ T < Th3, the filter size is determined to be “5”. When Th3 ≤ T, the filter size is determined to be “3”. In this manner, the filter size is reduced as the temperature rises.

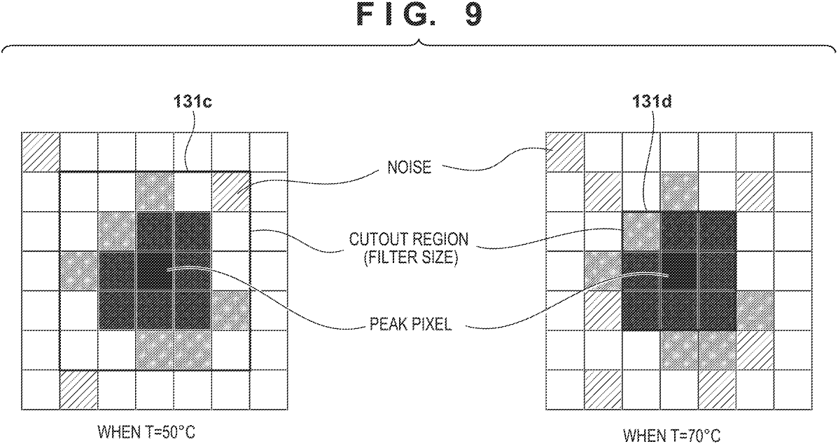

FIG. 9 illustrates a relationship between the filter size and the temperature T. When the temperature T is 50° C., the filter size is determined to be “5”, and a five pixel-by-five pixel partial image 131c is cut out. When the temperature T is 70° C., the filter size is determined to be “3”, and a three pixel-by-three pixel partial image 131d is cut out. The CPU 101 then moves from step S702 to step S614, and adds the filter size to the filter size list 123.

As another method for determining the filter size using temperature information, for example, the filter size may be determined according to distortion in the star image, using the temperature of the optical system. Furthermore, the filter size may be determined according to the peak luminance value as described in the first embodiment, and then fine-tuned according to the temperature.

### Third Embodiment

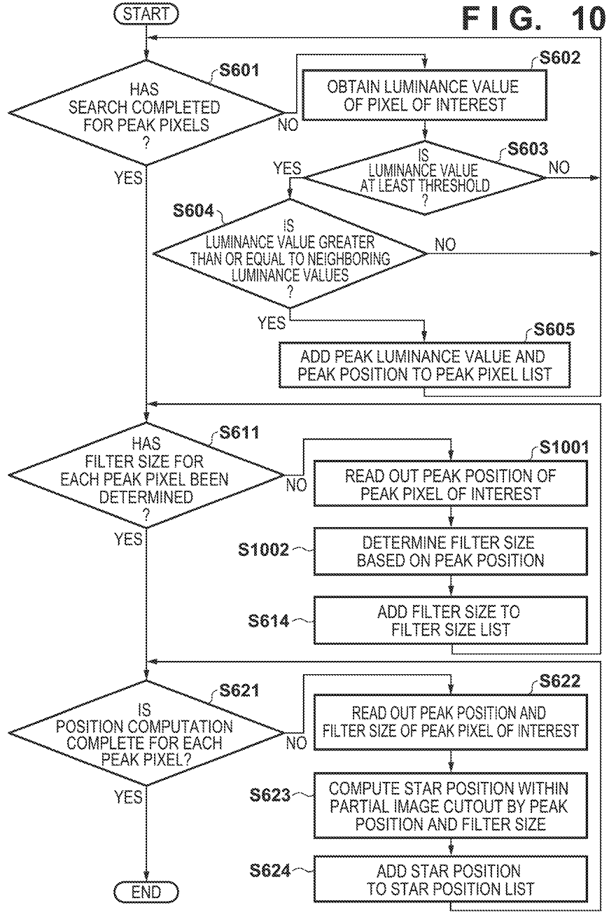

FIG. 10 is a flowchart illustrating a method for determining the filter position and size based on the position of the peak pixel in the overall image. Of the processes in FIG. 10, processes that are the same as in FIG. 6 are given the same reference signs, and will not be described. In other words, steps S612 and S613 in FIG. 6 are replaced with steps S1001 and S1002, respectively.

In step S1001, the CPU 101 (the size adjustment unit 2) reads out the peak position of the peak pixel of interest from the peak pixel list 122.

In step S1002, the CPU 101 (the size adjustment unit 2) determines the filter size based on the peak position of the peak pixel of interest, but before this, in the present embodiment, a provisional position is calculated to adjust the filter position by pseudo-correcting the position of the peak pixel of interest. The range where the filter is applied to the peak pixel of interest can be corrected (the filter position can be determined) by reading out the provisional position in step S622 and executing step S623.

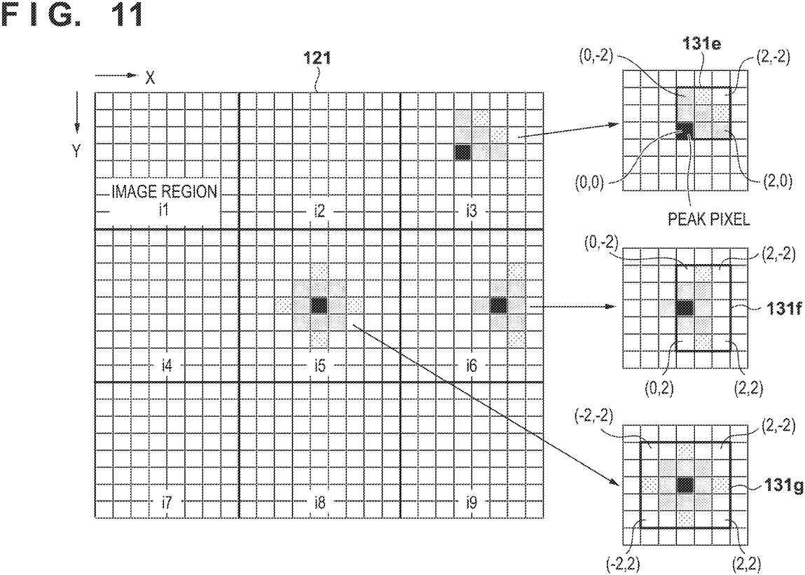

For example, as illustrated in FIG. 11, the size adjustment unit 2 divides the original image expressed by the image data 121 into nine image regions i1 to i9. The size adjustment unit 2 furthermore determines the provisional position of the peak pixel of interest according to the image region in which the peak pixel is present. The optical lens of the image sensor 4 generally has a characteristic in which an image tends to become distorted with distance from the image center. Accordingly, in light of the shape of the distortion, a provisional position can be determined for the peak pixel of interest in each image region in advance.

Specifically, as illustrated in FIG. 11, the provisional position is determined such that the filter is applied not centered on the peak pixel, but rather at a position shifted therefrom. In the image region i3, the provisional position is pre-set to be determined to be to the upper-right of the peak pixel.

As such, unlike the first and second embodiments, which use the peak luminance value or temperature and cut out the partial image 131 based on a filter centered on the peak pixel, the third embodiment determines the filter position based on the position of the peak pixel relative to the overall image.

This is because the tendency of the star image to distort differs from image region to image region, and thus depending on the image region, the peak pixel may be present at a position different from the center of the star image (that is, closer to the center of the overall image). Accordingly, setting the filter position with respect to the position of the peak pixel defined in each image region makes it easier to cut out only the star image.

The size adjustment unit 2 furthermore determines the filter size based on the image region in which this peak pixel is present. In FIG. 11, the filter size is reduced with proximity to the edges of the image. However, when the provisional position is set here, the size adjustment unit 2 does not absolutely have to change the filter size for each image region, such as when image distortion can be absorbed by setting the provisional position. The same filter size may be determined for some or all of the image regions, or the filter size may be determined based on the method of the first embodiment, the second embodiment, or the like.

An example of a case where the filter size is reduced with proximity to the edges of the image will be described in detail. In the image region i3 in FIG. 11, the provisional position is set at (1,-1) with respect to coordinates (0,0) of the peak pixel, and a 3×3 filter is applied to the peak pixel at (0,0), the region of the filter being the region within (0,-2), (0,0), (2,-2), and (2,0). In the image region i6, the provisional position is set at (1,0) with respect to coordinates (0,0) of the peak pixel, and a 3×4 filter is applied to the peak pixel at (0,0), the region of the filter being the region within (0,-2), (0,2), (2,-2), and (2,2). In the image region i5, the provisional position is set at (0,0) with respect to coordinates (0,0) of the peak pixel, and a 4×4 filter is applied to the peak pixel at (0,0), the region of the filter being the region within (-2,-2), (-2,2), (2,-2), and (2,2).

Note that the example of changing the filter size described in the foregoing embodiment is merely one example, and is not limited thereto. For example, the filter size may be increased with distance from the center of the overall image. This makes it possible to handle the tendency of the image to stretch at the edges of the image due to the optical design. Even in this case, it is preferable that the provisional position for adjusting the position of the filter be set, relative to the peak pixel of interest, in a direction further from the center of the image than the position of the peak pixel of interest (the upper-right, in the image region i3 in FIG. 11).

As another method for determining the filter position and the filter size, the filter position and the filter size may be determined according to the relative position of the peak pixel with respect to the center of the original image. The filter size determined based on the peak luminance value and the temperature as described in other embodiments may be fine-tuned even further according to the position of the peak pixel.

According to the embodiments, pixels used to calculate a star position can be extracted without performing repeated calculations as in past methods. Accordingly, luminance weighted averaging is executed within a range based on the expected size of the star image. This makes it possible to execute star position calculations quickly while reducing noise. The star position is calculated within a partial image cut out at a filter size set appropriately according to the peak luminance value, the temperature, or the shape of the star image. This reduces the probability of the partial image containing noise. The star tracker identifies a star based on the positions of the star candidates, calculates the attitude from the direction vector of the identified star, and outputs the calculation result. This suppresses a drop in the probability of the star being identified and a drop in accuracy of the attitude caused by noise.

The present invention is not limited to the methods described in the foregoing embodiments. Various changes can be made without departing from the essential spirit of the present invention, and the embodiments can also be used in combination. For example, as mentioned above, the filter size may be determined according to the peak luminance value as described in the first embodiment, and the filter size may then be corrected using the temperature of the image sensor 4 as described in the second embodiment. The filter size may be further corrected according to the position of the peak pixel as described in the third embodiment.

### Technical Spirit Derived From Embodiments

### Aspect 1

As illustrated in FIG. 1, the image sensor 4 is an example of an image capture module that captures an image of a star and outputs the image. The CPU 101 and the peak search unit 1 function as a search module that searches out, from a plurality of pixels constituting the image, a peak pixel having a luminance value higher than luminance values of neighboring pixels neighboring the peak pixel. The CPU 101 and the size adjustment unit 2 function as a determination module that determines an extraction range from which to extract, from the image, a partial image containing the peak pixel. The extraction range may be a cutout size for cutting out the partial image (e.g., the filter size), or may be a range of processing that results in a given range of pixels being extracted through image processing aside from cutting out. For example, a range extracted as a result of filtering, such as applying a bilateral filter, to remove pixels that satisfy a specific condition, is also included in this extraction range. The CPU 101 and the position computation unit 3 function as a computing module that computes a star position based on luminance values of a plurality of pixels constituting the partial image. Here, the CPU 101 and the size adjustment unit 2 determine the extraction range based on at least one of the luminance value of the peak pixel, a position of the peak pixel within the image, and a parameter correlated with a temperature of the image capture module, such that noise in the partial image is reduced. This makes it possible to reduce the number of memory accesses and the computation time as compared to the past. Furthermore, because noise in the partial image is reduced, the accuracy of computing the star position can be improved as well.

### Aspect 2

The CPU 101 and the size adjustment unit 2 may determine the extraction range based on the luminance value of the peak pixel such that the extraction range of the partial image expands as the luminance value of the peak pixel contained in the partial image increases. As illustrated in FIG. 7, a larger extraction range can be set as the luminance value of the peak pixel increases. Conversely, a smaller extraction range can be set as the luminance value of the peak pixel decreases. This is thought to reduce the effect of noise.

### Aspect 3

The temperature of the image capture module, the temperature of a substrate on which the image capture module is mounted, the temperature of an optical system of the image capture module, and the temperature of the housing of the star tracker can be given as examples of parameters correlated with the temperature of the image capture module. Accordingly, the temperature sensor 9 functions as a temperature sensing module. As illustrated in FIG. 9, the CPU 101 and the size adjustment unit 2 may determine the extraction range such that the extraction range of the partial image shrinks as the temperature of the image capture module rises. In other words, the CPU 101 and the size adjustment unit 2 may determine the extraction range such that the extraction range of the partial image expands as the temperature of the image capture module drops.

### Aspects 4, 5, and 6

As described in the third embodiment, the CPU 101 and the size adjustment unit 2 may determine a cutout position, the extraction range, and the like based on the position of the peak pixel within the image. For example, the CPU 101 and the size adjustment unit 2 may determine the extraction range in accordance with optical image distortion according to the position of the peak pixel within the image. This reduces the effect of image distortion, which improves the accuracy of the star position computation.

### Aspect 7

As illustrated in FIG. 11, the image may be constituted by a plurality of image regions. The extraction range may be set in advance for each of the plurality of image regions. The CPU 101 and the size adjustment unit 2 may determine the extraction range in accordance with which of the plurality of image regions the peak pixel belongs to. This reduces the effect of image distortion, which improves the accuracy of the star position computation.

### Aspect 8

As illustrated in FIG. 11, coordinates of vertices of a partial image cut out based on the extraction range may be set in advance for each of the plurality of image regions as relative coordinates relative to coordinates of the position of the peak pixel. This reduces the effect of image distortion, which improves the accuracy of the star position computation.

### Aspect 9

The CPU 101 and the size adjustment unit 2 may determine a shape of the partial image in accordance with optical image distortion according to the position of the peak pixel within the image. The shape may be a square, a rectangle, or a rhombus. Alternatively, a more complex shape may be defined to reduce the effect of image distortion. This reduces the effect of image distortion, which improves the accuracy of the star position computation.

### Aspect 10

A star position computation method is also provided, as illustrated in FIGS. 6, 8, 10, and the like. The star position computation method includes, for example: an image capture step of an image capture module capturing an image of a star and outputting the image; a search step of searching out, from a plurality of pixels constituting the image, a peak pixel having a luminance value higher than luminance values of neighboring pixels neighboring the peak pixel; a determination step of determining an extraction range from which to extract, from the image, a partial image containing the peak pixel; and a computation step of computing a star position based on luminance values of a plurality of pixels constituting the partial image. The determination step determines the extraction range based on at least one of the luminance value of the peak pixel, a position of the peak pixel within the image, and a parameter correlated with a temperature of the image capture module, such that noise in the partial image is reduced.

### Aspect 11

A program that causes a computer to function as the star tracker according to any one of Aspects 1 to 8 is provided. As illustrated in FIG. 1, this program is stored in the memory 103.

The invention is not limited to the foregoing embodiments, and various variations/changes are possible within the spirit of the invention.

What is claimed is:

1. A star tracker comprising:
an image sensor configured to capture an image of a star and output the image; and
at least one processor configured to:
search out, from a plurality of pixels constituting the image, a peak pixel having a luminance value higher than luminance values of neighboring pixels neighboring the peak pixel;
determine an extraction range from which to extract, from the image, a partial image containing the peak pixel; and
compute a star position based on luminance values of a plurality of pixels constituting the partial image,
wherein the at least one processor is further configured to determine the extraction range based on at least one of the luminance value of the peak pixel, a position of the peak pixel within the image, and a parameter correlated with a temperature of the image sensor, such that noise in the partial image is reduced.

2. The star tracker according to claim 1, wherein the at least one processor is further configured to determine the extraction range based on the luminance value of the peak pixel such that the extraction range of the partial image expands as the luminance value of the peak pixel contained in the partial image increases.

3. The star tracker according to claim 1, further comprising:
a temperature sensor that senses, as the parameter correlated with the temperature of the image sensor, at least one of the temperature of the image sensor, a temperature of a substrate on which the image sensor is mounted, a temperature of an optical system of the image sensor, and a temperature of a housing of the star tracker,
wherein the at least one processor is further configured to determine the extraction range based on the parameter such that the extraction range of the partial image shrinks as the temperature of the image sensor rises.

4. The star tracker according to claim 1, wherein the at least one processor is further configured to set a cutout position in the extraction range based on the position of the peak pixel within the image.

5. The star tracker according to claim 3, wherein the at least one processor is further configured to determine the extraction range based on the position of the peak pixel within the image.

6. The star tracker according to claim 5, wherein the at least one processor is further configured to determine the extraction range in accordance with optical image distortion according to the position of the peak pixel within the image.

7. The star tracker according to claim 5, wherein the image is constituted by a plurality of image regions, the extraction range is set in advance for each of the plurality of image regions, and the at least one processor is further configured to determine the extraction range in accordance with which of the plurality of image regions the peak pixel belongs to.

8. The star tracker according to claim 7, wherein coordinates of vertices of a partial image cut out based on the extraction range are set in advance for each of the plurality of image regions as relative coordinates relative to coordinates of the position of the peak pixel.

9. The star tracker according to claim 1, wherein the at least one processor is further configured to determine a shape of the partial image in accordance with optical image distortion according to the position of the peak pixel within the image.

10. A method comprising:
an image sensor capturing an image of a star and outputting the image;
at least one processor searching out, from a plurality of pixels constituting the image, a peak pixel having a luminance value higher than luminance values of neighboring pixels neighboring the peak pixel;
the at least one processor determining an extraction range from which to extract, from the image, a partial image containing the peak pixel; and
the at least one processor computing a star position based on luminance values of a plurality of pixels constituting the partial image,
wherein the determining includes determining the extraction range based on at least one of the luminance value of the peak pixel, a position of the peak pixel within the image, and a parameter correlated with a temperature of the image sensor, such that noise in the partial image is reduced.

11. A computer readable storage medium storing a computer program code for causing at least one processor:
to cause an image sensor to capture an image of a star and output the image;
to search out, from a plurality of pixels constituting the image, a peak pixel having a luminance value higher than luminance values of neighboring pixels neighboring the peak pixel;
to determine an extraction range from which to extract, from the image, a partial image containing the peak pixel; and
to compute a star position based on luminance values of a plurality of pixels constituting the partial image,
wherein the determining includes determining the extraction range based on at least one of the luminance value of the peak pixel, a position of the peak pixel within the image, and a parameter correlated with a temperature of the image sensor, such that noise in the partial image is reduced.
